(19) United States
(12) Patent Application Publication
(10) Pub. No.: US 2005/0020137 A1
(43) Pub. Date: Jan. 27, 2005

(54) Connector and contact for the connector

(76) Inventors: Hirohisa Tanaka, Tsu-shi (JP); Masato Kawashima, Tsu-shi (JP)

Correspondence Address: GREENBLUM & BERNSTEIN, P.L.C., 1950 ROLAND CLARKE PLACE, RESTON, VA, 20191, US

(21) Appl. No.: 10/496,308

(22) PCT Filed: Oct. 22, 2003
(86) PCT No.: PCT/JP03/13501

(30) Foreign Application Priority Data
Nov. 30, 2002 (JP) 2002-316602

(51) Int. Cl. H01R 24/00

(52) U.S. Cl. 439/630

(57) ABSTRACT

In a connector used for recording and reproducing apparatus of a memory card, it is aimed to prevent an instantaneous make break phenomenon, in which a contact portion of a contact and a terminal of a memory card is instantaneously opened and suppliance of electric power to the memory card is instantaneously stopped when an impact is applied to the connector, and a deformation of the contact due to the impact. Three plate spring portions arranged in parallel with each other and three contact portions respectively provided in the vicinities of front ends of the plate spring portions are formed in the vicinity of a front end of the contact. Two plate spring portions among three plate spring portions, for example, the plate spring portions disposed at both sides are integrally combined at the front end portions of them. A length of another plate spring portion, for example disposed at the center is made shorter than the lengths of the others. Thus, a number of contact portions can be increased without reducing mechanical strength of the front end portion of the contact.

### TECHNICAL FIELD

The present invention relates to a connector used, for example, in a memory card recording and reproducing apparatus and contact for the connector.

### BACKGROUND ART

A connector for a memory card recording and reproducing apparatus is conventionally proposed as shown, for example, in a publication gazette of Japanese patent application 2001-357943, so as to readout data from a memory card such as an SD memory card or a multi-media card (MMC) or to record the data into the memory card.,

In such the connector for memory card recording and reproducing apparatus, an opening, through which the memory card is inserted or removed, is provided on a front face of a box-shaped housing, and a plurality of contacts, which is to be contacted with a plurality of terminals provided on the memory card, is arranged in a main body of the housing. Generally, each contact is formed by bending a metal material with elasticity to a predetermined shape, and a contact portion having substantially a doglegged section is provided at a front end portion thereof.

When the memory card is inserted into the housing, the contact portions of the contacts are respectively contacted with the terminals of the memory card, and then the contacts are elastically deformed. Owing to the elastic deformations of the contacts, predetermined contacting pressures are generated at the contact portions, so that electric connections between the contacts and the terminals of the memory card can be maintained.

Since the memory card itself is very thin and small, it is required to make the connector for memory card recording and reproducing apparatus thin and small, accordingly. Thus, a very thin plate is used as the metal material of the contacts. Furthermore, the elastic deformations of the contacts when they contact with the terminals of the memory card are also small.

When an impact due to dropping or the like is applied to such the connector for memory card recording and reproducing apparatus, a phenomenon called “instantaneous make break phenomenon” occurs, in which contact of the contact portion and the terminal are instantaneously broken and made soon against the contacting pressure owing to the deformation of the contact. If such the instantaneous make break phenomenon occurs in an electric power terminal (or a grounded terminal) for supplying electric power to the memory card, a suppliance of electric power to the memory card is instantaneously stopped, it is called “instant stop”. When the instant stop occurs while the data are recorded into the memory card, it is highly possible that the data recorded into the memory card are damaged. Furthermore, since the mechanical strength of the contact is small, it is possible that the contact will be deformed due to the impact.

In order to reduce the occurrence of the above-mentioned instantaneous make break phenomenon, or to shorten a time period while the contact of the contact portion of the contact and the terminal are broken due to the instantaneous make break phenomenon, as shown in FIGS. 12A and 12B, it can be considered that a width of a portion 202 of a contact 200 except a contact portion 201 is made wider so as to increase elastic force. It, however, is difficult to obtain sufficient effects, since a pitch between the terminals on the memory card is previously decided, and there is a limit to widen the width of the contact 200.

Alternatively, as shown in FIGS. 13A to 13D, it can be considered that a slit having a predetermined shape is formed at a front end portion of a contact 210, and two sets of contact portions 211a and 211b, and arms 212a and 212b, which are independently functional, are provided. In such the case, it is possible to reduce the occurrence of the instantaneous make break phenomenon owing to providing two contact portions 211a and 211b than the case of one contact portion. Such the shape can be realized when the degrees of freedom for the length and the shapes of the contact 210 is relatively higher. It, however, is difficult to be realized when the sizes and the pitch pf the contacts are limited such as the connector for memory card recording and reproducing apparatus. Even though the contact having such the shapes can be realized, the width of respective arms 212a and 212b becomes narrower than the case having one contact portion on a single arm, so that it is difficult to generated a sufficient contacting pressure due to the low mechanical strength. Furthermore, the contact portions 211a and 211b, and the arms 212a and 212b can easily be deformed when the memory card is inserted.

In the publication gazette of Japanese patent application 2002-100440, a slit is formed on a contact in longitudinal direction thereof for forming two plate spring portions respectively having different widths. Since masses, spring constants, contacting pressure, and so on of the plate spring portions are different, it is possible to prevent the simultaneous broken of the contact of the contact portions formed on two plate spring portions and the terminals of a counterpart element. The two plate spring portions, however, are completely separated by the slit, so that it is equivalent to two narrow contacts which are arranged in parallel, and the mechanical strength against the impact becomes small. As a result, it is highly possible that the contacts are deformed when an impact is applied to the contact.

### DISCLOSURE OF INVENTION

An object of the present invention is to provide a compact connector which is usable in a memory card recording and reproducing apparatus, and a contact for the connector, in which a possibility of occurrence of troubles due to the instantaneous make brake phenomenon when an impact is applied is reduced.

For achieving the above-mentioned object, a connector in accordance with an aspect of the present invention comprises: a housing having an opening, through which a counterpart member to be mounted on the connector is inserted; and a plurality of contacts, which is arranged in an inside of the housing and to be contacted with terminals provided on the counterpart member. At least one contact among the contacts has three plate spring portions respectively arranged in parallel. Three contact portions are respectively formed in the vicinity of front ends of the plate spring portions; and two plate spring portions among the three plate spring portions are integrally coupled at the front end portions thereof.

A contact for a connector in accordance with an aspect of the present invention is formed by processing a metal plate into a predetermined shape, and comprises three plate spring portions respectively arranged in parallel, and three contact portions respectively formed in the vicinity of front ends of the plate spring portions. Two plate spring portions among the three plate spring portions are integrally coupled at the front end portions thereof.

In such configurations, a number of contact portions is increased to three. In comparison with a case that two contact portions are formed at a front end portion of a contact, it is possible to reduce a possibility of instantaneous breaking the contact of the contact portions of a contact and a terminal of the counterpart member, or it is possible to shorten a time period of the instantaneous breaking. As a result, it is possible to reduce the possibility of occurrence of instantaneous make break phenomenon or the like. For example, it is possible to reduce occurrence of troubles such as data damage due to occurrence of instant stop while the data are recorded into a memory card MC (SIC).

Since the front ends of two plate spring portions are integrally coupled, the contact has a spring characteristic similar to that of the conventional contact having only one contact portion. Thus, in comparison with another contact having a predetermined shaped slit at a front end portion so as to make two contact portions independently be functional, it is possible to have a higher contact pressure and a higher mechanical strength than the contact. Accordingly, it is possible to reduce the possibility of breaking and deformation of the contact due to impact.

### BRIEF DESCRIPTION OF DRAWINGS

FIG. 1 is a perspective drawing showing appearances of a memory card and a connector in an embodiment of the present invention;

FIG. 2 is an exploded perspective drawing showing a configuration of the connector in the embodiment;

FIGS. 3A to 3D are drawings respectively showing a rear view, a plan view, a front view and a side view of a base shell in the embodiment;

FIGS. 4A to 4D are drawings respectively showing a rear view, a plan view, a front view and a side view of a cover shell in the embodiment;

FIGS. 5A to 5C are drawings respectively showing a rear view, a plan view and a front view of a contact block in the embodiment;

FIGS. 6A and 6B are drawings respectively showing a plan view and a right side view of a configuration in the vicinity of a front end portion of an arm of a slider in the embodiment;

FIGS. 6C and 6D are drawings respectively showing X-X section and Y-Y section in FIG. 6A;

FIG. 7 is a perspective drawing showing a configuration of a contact in the embodiment;

FIG. 8 is a drawing showing a bottom view of the contact;

FIG. 9 is a drawing showing a side view of the contact;

FIG. 10 is a drawing showing a rear view of the contact;

FIGS. 11A to 11C are drawings respectively showing a bottom view, a side view and a sectional side view of a modification of the contact in the embodiment;

FIGS. 12A and 12B are drawings respectively showing a side view and a bottom view of a referential example of a contact; and

FIGS. 13A to 13D are drawings respectively showing a plan view, a side view, a sectional side view and a front view of another referential example of a contact.

### BEST MODE FOR CARRYING OUT THE INVENTION

An embodiment of the present invention is described with reference to the drawings. A connector for SD memory card and a contact for the connector are described as examples of a connector and a contact for a connector in accordance with this embodiment. The present invention, however, is not limited to the connector for SD memory card and the contact thereof. It is possible to adopt the present invention to connectors entirely, which generates a contact pressure utilizing elastic deformation of the contact, and contacts a contact portion provided on the contact to a terminal provided on a counterpart member.

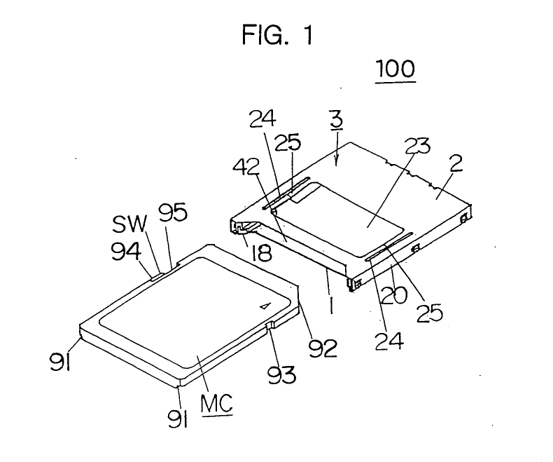

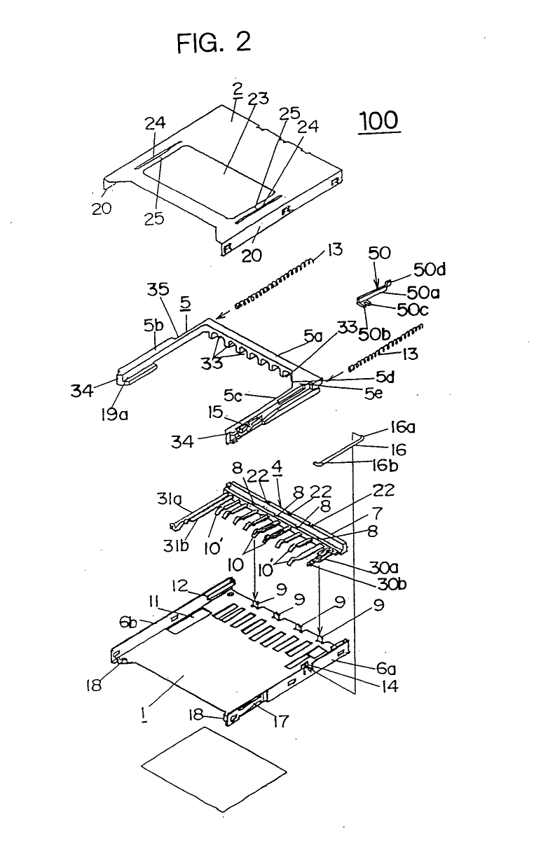

FIG. 1 is a perspective drawing showing appearances of a memory card such as an SD memory card designated by a symbol MC and a connecter 100. FIG. 2 is an exploded perspective view showing a configuration of the connector 100.

As shown in FIGS. 1 and 2, a planiform housing 3 of the connector 100 is configured by a base shell 1 and a cover shell 2, and the housing 3 has an opening 42 formed on a front face thereof. The memory card MC is inserted into an inside of the housing 3 through the opening 42. The base shell 1 is formed by punching a very thin stainless steel plate to a predetermined shape, and bending the punched plate (blank). Similarly, the cover shell 2 is formed by punching a very thin stainless steel plate to a predetermined shape, and bending the punched plate (blank). The housing 3 is assembled by engaging the cover shell 2 with the base shell 1. A contact block 4 is provided at a position in the vicinity of a rear end in the inside of the housing 3. A slider 5 having a shape similar to a section of a channel iron is movably provided between the opening 42 of the housing 3 and the contact block 4 in the housing 3. The slider 5 is made by a resin molding.

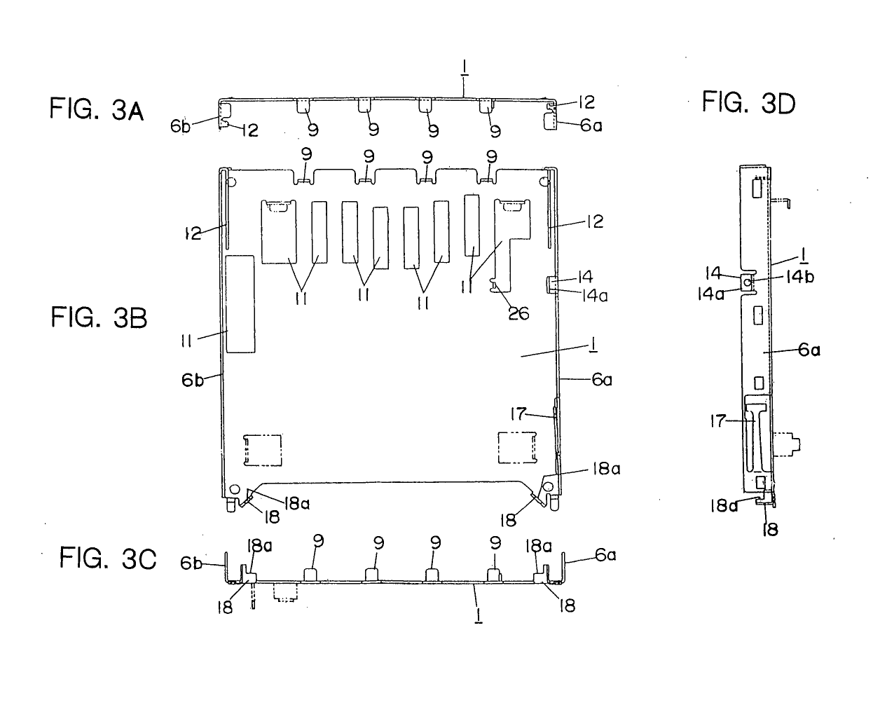

Details of the base shell 1 are described with reference to FIGS. 3A to 3D. FIG. 3A is a rear view of the base shell 1. FIG. 3B is a plan view of the base shell 1. FIG. 3C is a front view of the base shell 1. FIG. 3D is a side view of the base shell 1.

The base shell 1 has side walls 6a and 6b which are formed by bending both sides of the punched blank upwardly. Front end and rear end of the base shell 1 are opened. Four protrusions 9 are formed at a predetermined pitch in the vicinity of the rear end of the base shell 1 by bending the blank of the base shell 1 upwardly. The protrusions 9 are to be press-fitted into press-fitting through holes 8 of a resin molded base member 7 of the contact block 4 from the downside.

A plurality of holes 11 is formed on the bottom plate of the base shell 1 at positions a little forward from the rear end of the base shell 1 for preventing short-circuiting of a plurality of contacts 10, 10′ and switching pieces 30a, 30b, 31a and 31b which are held on the contact block 4.

A pair of spring guide rods 12 is formed parallel to the side walls 6a and 6b, and inward from the side walls 6a and 6b by bending protruded portions of the blank which are extended from the portions of the side walls 6a and 6b. Each of the spring guide rod 12 will respectively be fitted into a center hollow portion of a coil spring 13 for preventing the buckling of the coil spring 13 which is used for pressing the slider 5 forward.

As shown in FIG. 3B, an L-shaped protrusion 14 is formed at a position a little forward from the spring guide rod 12 by being bent from the side wall 6a. The L-shaped protrusion 14 bears an end of a rod 16 which is used for restricting the movement of the slider 5. In detail, the L-shaped protrusion 14 has a bearing 14b formed on a standing wall 14a. A rotation shaft 16a provided at an end of the rod 16 is rotatably borne by the bearing 14b. A hook 16b provided at the other end of the rod 16 is slidably engaged with a heart cam groove 15. The heart cam groove 15 is formed in the vicinity of a front end on an outer face of an arm 5c of the slider 5. Details of the heart cam groove 15 will be described afterward.

The rod 16 is disposed in a concave portion formed on the side face of the arm 5c which is formed to be parallel to the standing wall 14a, so that the hook 16b can be engaged with the heart cam groove 15.

A plate spring 17 is formed in the vicinity of the front end on the side wall 6a by embossing the side wall 6a for pressing a side face of the rod 16 toward the arm 5c of the slider 5.

As can be seen from FIGS. 1, 2 and 3B, both side front portions of the bottom plate of the base shell 1 are protruded forward than a center portion thereof. Inner peripheries of the protruded side front portions are slanted against a straight periphery of the center portion. A pair of stoppers 18 is formed on the slanted inner peripheries of the side front portions by bending the blank of the base shell 1 upwardly. The stoppers 18 prevent not only jumping out of the slider 5 but also miss-insertion of the memory card MC.

A span between the stoppers 18 corresponds to the opening 42 through which the memory card MC is inserted. Each stopper 18 has an upward offset 18a at an inner upper edge portion. As can be seen from FIG. 1, the memory card MC has a pair of elongate downward offsets 91 formed along both lower side edges thereof. A span between inner edges of the stoppers 18 above the upward offsets 18a is selected to be a little wider than the maximum width of the memory card MC. A height between an upper face of the bottom of the base shell 1 and a lower edge of the upward offset 18a is selected to be a little higher than a height of the downward offsets 91 of the memory card MC. A span between inner edges of the stoppers 18 below the upward offsets 18a is selected to be a little wider than the narrower width between the inner edges of the downward offsets 91 of the memory card MC.

By such a configuration, when the memory card MC is properly inserted so that the lower face of the memory card MC faces the upper face of the bottom of the base shell 1, the memory card MC can be inserted into the housing 3 through the opening 42 in a manner so that the downward offsets 91 of the memory card MC passes above the upward offsets 18a of the stopper 18. Alternatively, when the memory card MC is erroneously inserted so that the upper face of the memory card MC faces the upper face of the bottom of the base shell 1, both sides of the memory card MC in the vicinity of the upper face thereof cannot pass trough the passage between the stoppers 18, so that the erroneous insertion of the memory card MC can be prevented.

Another stopper 26 for preventing erroneous insertion of the memory card MC back to front is formed at a predetermined position on the bottom of the base shell 1 by bending the blank of the base shell 1. When the memory card MC is erroneously inserted back to front, the memory card MC can pass through the portion of the upward offsets 18a of the stoppers 18 in the opening 42. If there is no stopper, a rear end of the memory card MC at which no terminal is provided damages the contacts 10 and 10′ held on the contact block 4. Thus, the stopper 26 is formed at a position forward the contacts 10 and 10′ of the contact block 4 when the contact block 4 is provided on the base shell 1.

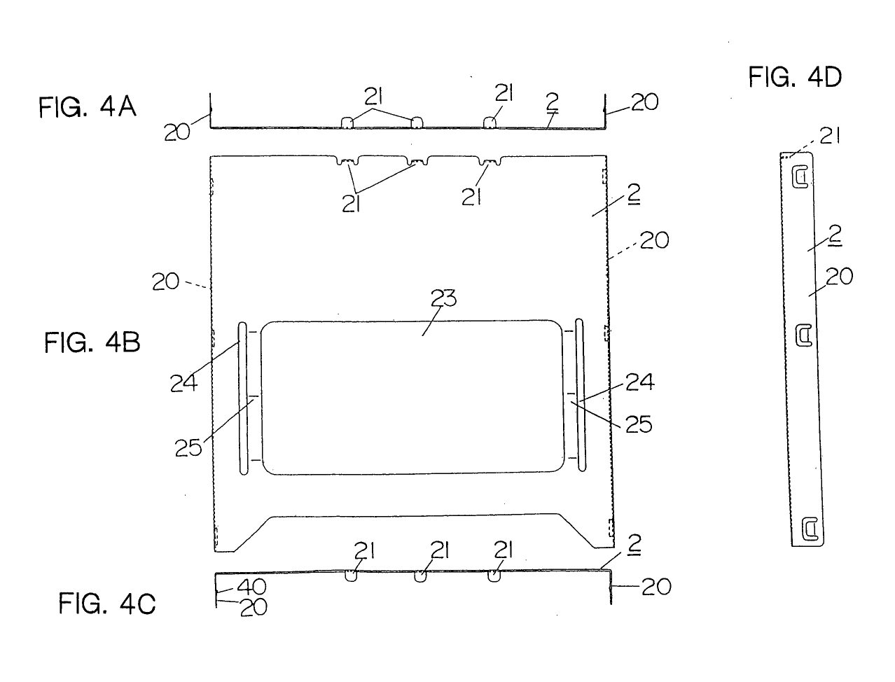

Details of the cover shell 2 are described with reference to FIGS. 4A to 4D. FIG. 4A is a rear view of the cover shell 4. FIG. 4B is a plan view of the cover shell 2. FIG. 4C is a front view of the cover shell 2. FIG. 4D is a side view of the cover shell 2.

The cover shell 2 has side walls 20 which are formed by bending both sides of the punched blank downwardly. Three protrusions 21 are formed at a predetermined pitch on a rear end of a top of the cover shell 2 by bending the blank of the cover shell 2 downwardly. The protrusions 21 are to be press-fitted to press-fitting through holes 22 of resin molded base member 7 of the contact block 4 on the base shell 1 from the upside, when the cover shell 2 is engaged with the base shell 1.

A window 23 through which a mark (not shown) printed on the top face of the memory card MC can be observed is formed at front portion on the top face of the cover shell 2 at the same time of punching the metal thin plate for forming the blank of the cover shell 2. A pair of slits 24 is further formed parallel to both sides of the window 23. Center portions of bridges 25 between the window 23 and the slits 24 are downwardly protruded from the lower face of the top of the cover shell 2. Peaks of the protruded bridges 25 serve as pressing portions to be contacted to the top face of the memory card MC and to press the memory card MC downward by elasticity, when the memory card MC is inserted into the housing 3.

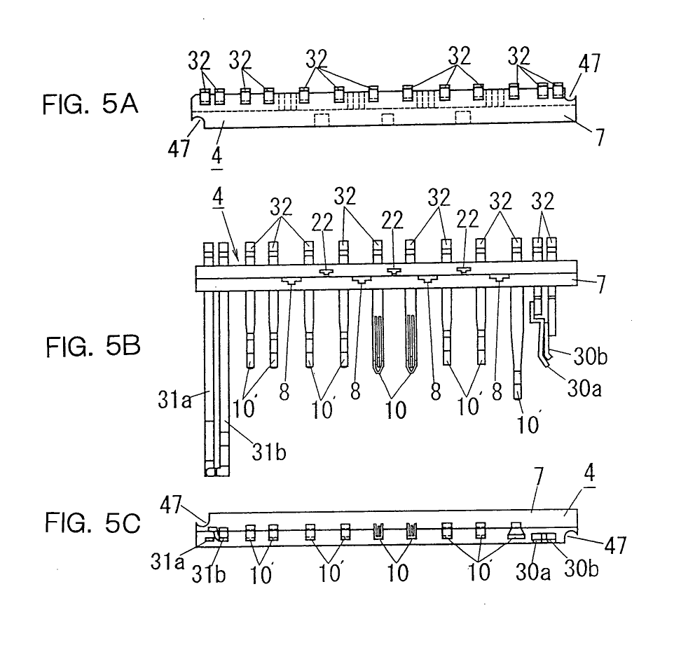

Details of the contact block 4 are described with reference to FIGS. 5A to 5C. FIG. 5A is a rear view of the contact block 4. FIG. 5B is a plan view of the contact block 4. FIG. 5C is a front view of the contact block 4.

As can be seen from the drawings, a plurality of (for example, nine for the SD memory card) the contacts 10 and 10′, a pair of the switching pieces 30a and 30b and a pair of the other switching pieces 31a and 31b are integrally held on the base member 7 of the contact block 4 which is formed by insert molding of resin. The contacts 10 and 10′ respectively contact the terminals on the lower face of the memory card MC. The switching pieces 30a and 30b are used for sensing whether the memory card MC is properly inserted or not. The switching pieces 31a and 31b are used for sensing a position of a writing protection switch SW of the memory card MC corresponding to on or off of the writing protection. The contact portions of the contacts 10 and 10′, and the switching pieces 30a, 30b, 31a and 31b are protruded from the base member 7 toward the opening 42 of the housing 3. Soldering terminals 32 of the contacts 10 and 10′, and the switching pieces 30a, 30b, 31a and 31b which are to be soldered on a circuit substrate are protruded backwardly from the base member 7. As shown in FIG. 5C, the base member 7 has an offset formed on a front top end thereof. The above-mentioned press-fitting through holes 8 are penetratingly formed on the offset of the base member 7. The press-fitting through holes 22 are penetratingly formed on the rear portion of the top face of the base member 7. As shown in FIGS. 5A and 5C, a pair of cuttings 47, into which rear ends of the coil springs 13 are fitted, is formed on both sides of the base member 7. One of the cuttings 47 is positioned at a lower end of the base member 7 and the other of the cuttings 47 is positioned at an upper end of the base member 7. Details of the contact 10 will be described afterward.

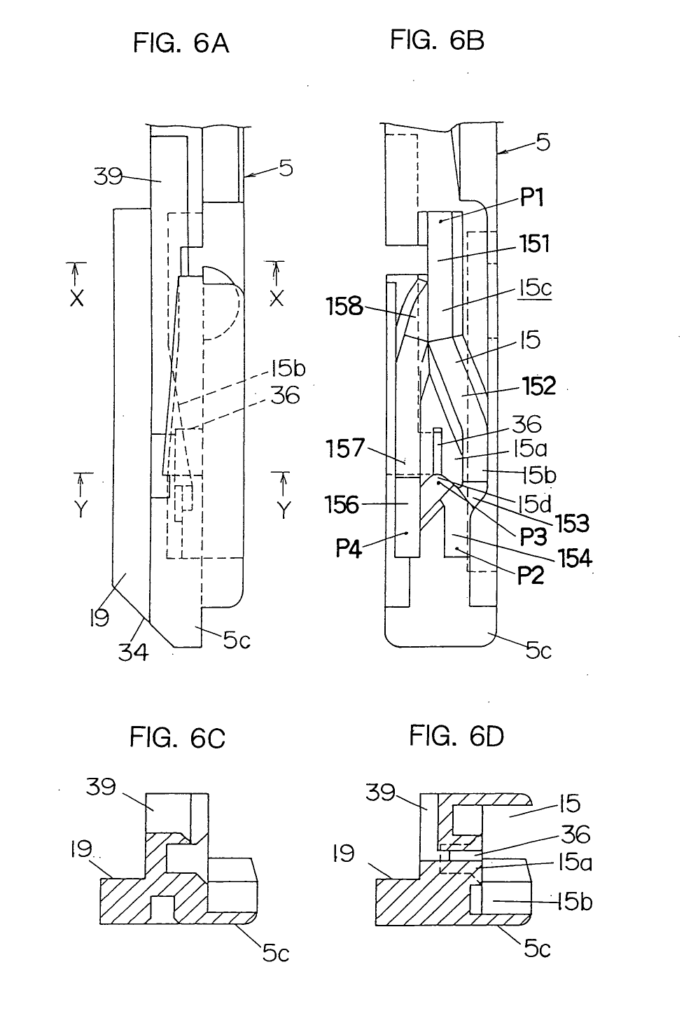

Details of the slider 5 are described with reference to FIGS. 2 and 6A to 6D. As shown in FIG. 2, the slider 5 is formed substantially a shape of a section of a channel iron by resin molding. The arms 5b and 5c are protruded forward from a transverse portion 5a of the slider 5. An array of grooves 33 are formed on the lower face of the transverse portion 5a of the slider 5. Since the slider 5 moves forward and backward in the inside of the housing 3, the grooves 33 prevent the collision of the slider 5 with the contacts 10 and 10′, and the switching pieces 30a, 30b, 31a and 31b of the contact base 4.

The arms 5b and 5c serve as guide portions for guiding both sides of the memory card MC. Slanted faces 34 are formed at front ends of the arms 5b and 5c in a manner so that a distance between the inner side faces of the arms 5b and 5c gradually increases toward the end.

A narrow groove 35 having substantially U-shaped section is provided on the left arm 5b toward the center from the upper rear end. The rear end and the left side of the groove 35 are opened. Similarly, a narrow groove (not shown) having substantially U-shaped section is provided on the right arm 5c toward the center from the lower rear end. The rear end and the right side of the latter groove are opened.

The coil springs 13 are respectively fitted into the grooves 35 and so on. Dead ends of the grooves 35 and so on respectively receive the pressing forces of the coil springs 13. Since both of the arms 5b and 5c evenly receive the pressing forces of the coil springs 13 forwardly, the slider 5 can move in the inside of the housing 3 of the connector 100 smoothly.

A pair of guide rails 19, on which the downward offsets 91 of the memory card MC are slidably disposed, is integrally formed on the inner side faces of the arms 5b and 5c of the slider 5.

The heart cam groove 15 is formed at a portion in the vicinity of the front end on the outer side face of the right arm 5c. As shown in FIGS. 6A and 6B, the hear cam groove 15 is configured by a heart cam 15a and a guide groove 15b. The guide groove 15b further comprises a first to eighth sub-grooves 151 to 158. The hook 16b of the rod 16 is slidably engaged with the guide groove 15b. Following to the forward and backward movement of the slider 5, the hook 16b of the rod 16 moves a predetermined way along the guide groove 15b with being guided by the side walls of the guide groove 15b and the heart cam 15a and the convex and concave elevation of the bottom 15c of the sub-grooves 151 to 158 of the guide groove 15b. Details of the heart cam groove 15 will be described afterward.

As shown in FIG. 2, a protrusion Se having a slant 5d, with which a slanted cutting 92 on the front end of the memory card 27 (SIC) can be fitted, is formed at an inner corner between the transverse member 5a and the right arm 5c of the slider 5.

A locking member 50 is formed by punching and bending of a metal thin plate such as a stainless steel having elasticity. The locking member 50 has a lever portion 50a which is an elongate plate and will be disposed in parallel with the inner side face of the arm 5c when the locking member 50 is held on the arm 5c. The protrusion 50b is bent from an edge in the vicinity of a lower front end of the lever portion 50a toward a direction substantially perpendicular to the lever portion 50a. The contact portion 50c is formed to be protruded from the lever 50a at a portion in the vicinity of a rear edge of the protrusion 50b in a manner so that the center portion of the contact portion 50c is outwardly embowed. A locking hook 50d is formed in the vicinity of a rear end portion of the lever portion 50a, which has a crank shaped section.

The locking member 50 is held on the arm 5c by fitting the protrusion 50b and the contact portion 50c into a holding groove 36 provided on the arm 5c (see FIGS. 6B and 6D). When the protrusion 50b and the contact portion 50c are fitted into the holding groove 36 on the arm 5c, the front end of the protrusion 50b of the locking member 50 is extruded in the recess 15d of the hart cam groove 15. As shown in FIGS. 6C and 6D, a concave portion 39, which is opened to the upside of the arm 5c and the inner space between the arms 5b and 5c, is formed on the arm 5c. The lever portion 50a of the locking member 50 is disposed in the concave portion 39 of the arm 5c.

An inner width of the holding groove 36 is formed to be wider than the width at the opening thereof. Thus, when the protrusion 50b and the contact portion 50c are fitted into the holding groove 36, the contact portion 50c is hooked with the edge of the opening of the holding groove 36, so that the locking member 50 is never unloosen from the holding groove 36. On the other hand, the protrusion 50b and the contact portion 50c are movable in the holding groove 36. Since the front end of the protrusion 50b of the locking member 50 is extruded in the recess of the hart cam groove 15, when the hook 16b of the rod 16 is fitted to the recess 15d, the front end of the protrusion 50b of the locking member 50 is backwardly pressed via the hook 16b due to the pressing forces of the coil springs 13 which presses the slider 5 forward. The rear end portion of the lever portion 50a is elastically deformed for warping toward the memory card MC by the pressing force. The locking hook 50d is extruded from the concave portion 39 and engaged with the cutting 93 of the memory card MC. Thus, the memory card MC is locked so as not to be drawn out from the housing 3 of the connector 100.

On the other hand, when the hook 16b of the rod 16 is out from the recess 15d of the heart cam groove except the locking state of the memory card MC, the pressing force for pressing the protrusion 50b of the locking member 50 is not acted. Thus, the locking hook 50d of the locking member 50 is evacuated from the cutting 93 of the memory card MC to the concave portion 39 on the arm 5c due to the elastic restitution force of the lever portion 50a. Then, the locking of the cutting 93 of the memory card MC by the locking hook 50d is released.

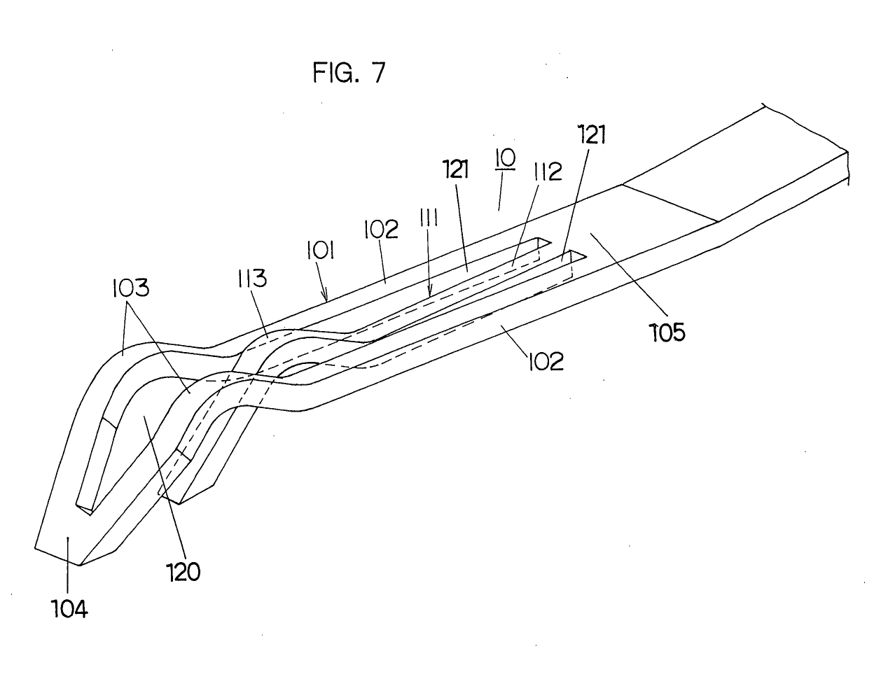

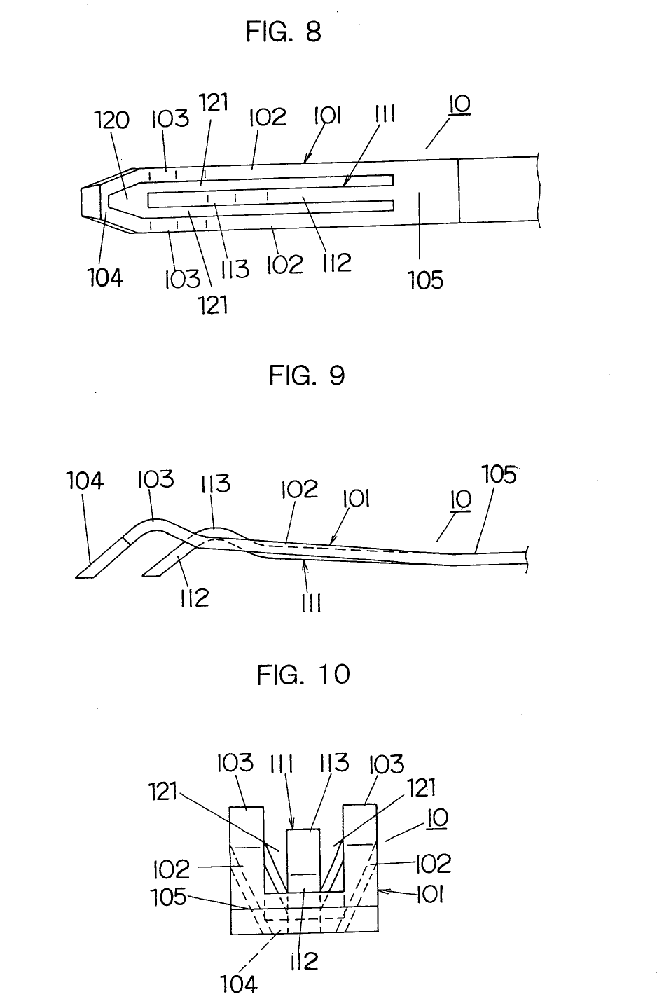

Subsequently, the detailed configuration of the contact 10 is described with reference to FIGS. 7 to 10. For example, as shown in FIG. 5B, two contacts 10, which are to be contacted with electric power terminals (V_{DD} and V_{SS}) of the memory card MC, among nine contacts 10 and 10′ held on the base member 7 of the contact block 4, that is, the fourth (V_{DD}) and the fifth (V_{SS}) contacts 10 from the right end in FIG. 5B, have different configuration from the other contacts 10′ having the same configuration as those of the conventional one.

As shown in FIGS. 7 to 10, two parallel slits 121 are formed on the contact 10 so that front ends 120 of the slits 121 are communicated, and the contact 10 is configured by a first contact component 101 disposed outside slits 121 and a second contact portion 111 between the slits 121. The first contact component 101 has a pair of narrow plate spring portions 102 in parallel with each other, contact portions 103 which are formed by bending vicinities of front ends of the plate spring portions 102 so as to be doglegged protruding toward the terminals of the memory card MC, a front end portion 104 having substantially V-shape and coupling the plate spring portions 102, and a stem portion 105 coupled with the second contact portion 111. The second contact component 111 has a plate spring portion 112 protruded from the stem portion 105 between and in parallel with the two plate spring portions 102 of the first contact portion 101, and a contact portion 113 which is formed by bending a vicinity of a front end of the plate spring portion 112. That is, three plate spring portions 102 and 112 are arranged in parallel with each other.

Since the second contact component 111 is formed inward of the first contact component 101, the length of the plate spring portion 112 of the second contact component 111 is shorter than the lengths of the plate spring portions 102 of the first contact component 101. Furthermore, the contact portion 113 of the second contact component 111 is positioned backward from the contact portions 103 of the first contact component 101.

In this manner, the contact 10 entirely has three contact portions 103 and 113, and elastically contacts with the electric power terminal (not shown) of the memory card MC at these three contact portions 103 and 113. Thus, even when an impact or the like is applied to the connector 100 from the outside, the possibility of occurrence of the instantaneous make break phenomenon with respect to the electric power terminals can be reduced, or endurance thereof can be shortened, in comparison with the contact having two contact portions, for example, shown in FIGS. 13A to 13D. As a result, the possibility of occurrence of instant stop due to the instantaneous make break phenomenon can be reduced, so that the possibility of occurrence of trouble such as damage of data due to the instant stop can be reduced, while the data is recorded into the memory card MC.

Furthermore, since the two plate spring portions 102 of the first contact component 101 are coupled by the front end portion 104, the contact 10 has a spring characteristic similar to that of the contact 10′ on which no slit 121 is formed. Thus, in comparison with a contact which is configured for operating two contact portions independently by forming a predetermined shaped slit is formed on a front end portion thereof, a higher contact pressure and a higher strength can be obtained than those of the contact.

Still furthermore, since the second contact component 111 is disposed inward of the first contact component 101, the contact 10 is not upsized, although the number of the contact portions 103 and 113 is increased to three. Thus, it is possible to use it in a compact connector such as the connector for the memory card recording and reproducing apparatus.

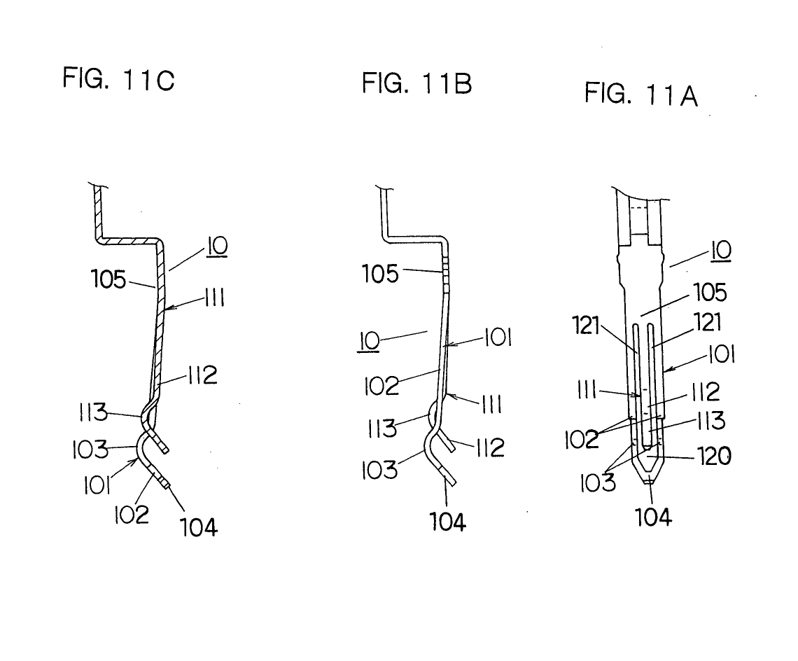

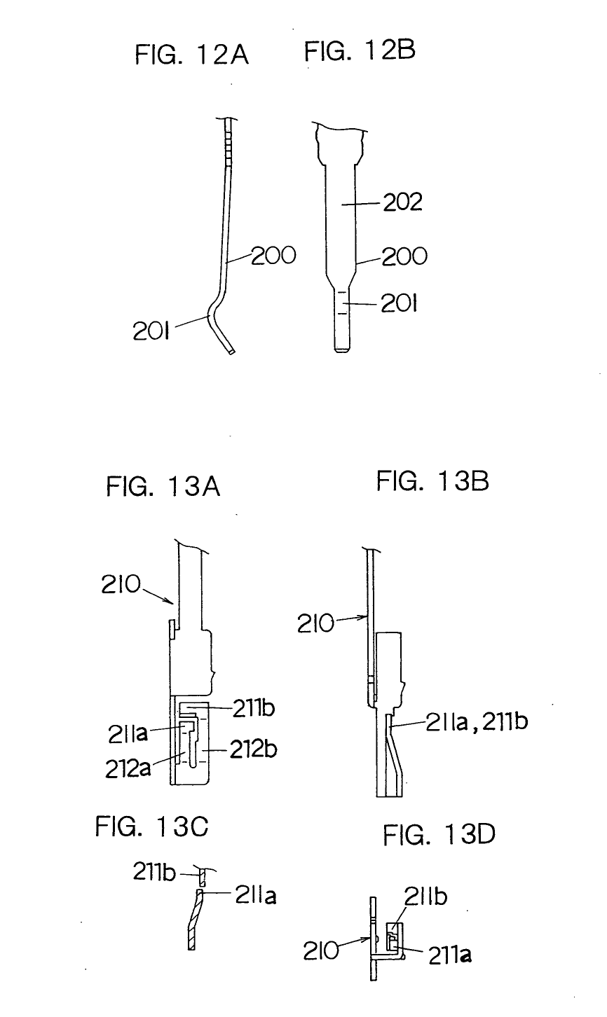

As shown in FIGS. 11A to 11C, it is possible to make the widths of the front end portion 104 and the plate spring portions 102 in the vicinity of the contact portions 103 of the first contact component 101 narrower within the limit that a sufficient contact pressure can be obtained.

The contact in accordance with the present invention is not limited to the above-\hat{ }mentioned embodiment, and it is sufficient to have at least three plate spring portions arranged in parallel with each other and three contact portions respectively formed in the vicinities of front ends of the plate spring portions, and two plate springs among the three plate springs are integrally coupled at the front end portions thereof. In such a case, effect similar to the above-mentioned case can be obtained.

Subsequently, motion of respective portions when the memory card MC is inserted into the housing 3 of the connector 100 is described.

When the memory card MC is properly inserted through the opening 42 of the housing 3 with respect to upside and downside, and front and rear, the downward offsets 91 at both lower sides of the memory card MC passes above the upward offsets 18a of the stopper 18 formed at the front end of the base shell 1. The front end of the memory card MC can be inserted in the space between the arms 5b and 5c of the slider 5 in the housing 3, and the downward offsets 91 of the memory card MC are held on the guide rails 19. When the memory card MC is further inserted into the housing 3, the slanted cutting 92 on the front end of the memory card MC fits to the slant 5d on the web Se of the slider 5, so that the slider 5 is pushed backward. When the memory card MC is further pushed against the pressing forces of the coil springs 13 which are applied to the slider 5, the slider 5 starts to move backward corresponding to the insertion of the memory card MC.

When the slider 5 starts to move, the hook 16b of the rod 16 relatively starts to move in the guide groove 15b of the heart cam groove 15 corresponding to the movement of the slider 5. The hook 16b of the rod 16 is positioned at a position P1 in the first sub-groove 151 shown in FIG. 6B. When the slider 5 moves backward, the hook 16b relatively moves forward in the first sub-groove 151 of the guide groove 15b. Since the elevation of the bottom of the eighth sub-groove 158 in the direction perpendicular to the paper sheet of FIG. 6B is higher than that of the first sub-groove 151, the hook 16b cannot proceed to the eighth sub-groove 158. Thus, the rod 16b proceeds in the second sub-groove 152 and reaches to the third sub-groove 153. Since the bottom of the second sub-groove 152 is sloped, the elevation of the bottom of the third sub-groove 153 is the highest in the guide groove 15b.

When the slider 5 stops at the dead end, the hook 16b proceeds to the fourth sub-groove 154 and stops at a position P2 where is a little shorter than the dead end of the fourth sub-groove 154. When the pressing force to the memory card MC is released, the slider 5 moves a little forward due to the pressing forces of the coil springs 13. The hook 16b relatively moves backward in the fourth sub-groove 154 corresponding to the forward movement of the slider 5. Since the elevation of the bottom of the third sub-groove 153 is higher than that of the fourth sub-groove 154, and the elevation of the bottom of the fourth sub-groove 154 is higher than that of the fifth sub-groove 155, the hook 16b must proceed to the fifth sub-groove 155.

In the fifth sub-groove 155, a recess 15d, to which the hook 16b is to be fitted, is formed on the side wall of the heart cam 15a. When the hook 16b proceeds to the fifth sub-groove 155, the hook 16b fits to the recess 15d at a position P3. Thus, the forward movement of the slider 5 is stopped due to the balancing of the pressing forces of the coil springs 13 and the reaction force acting between the heart cam 15a and the hook 16b of the rod 16.

While the above mentioned movement of the memory card MC, the contact portions of the contacts 10 and 10′ protruded forward through the grooves 33 of the transverse member 5a of the slider 5 respectively contact the terminals of the memory card MC which are provided on the lower face of the memory card MC. As can be seen from FIG. 5B, the contacts 10 and 10′ respectively have different length, so that the contacts serially contact the terminals of the memory card MC corresponding to the length thereof.

When the slanted cutting 92 on the front end of the memory card MC contacts the switching piece 30a, the switching piece 30a warps so that the contact portion of the switching piece 30a contacts the switching piece 30b. By applying a predetermined voltage between the switching pieces 30a and 30b, a switching on signal can be outputted from the switching pieces 30a and 30b. It is possible to sense whether the memory card MC is properly inserted or not by an external sensing circuit (not shown in the figure) with using the switching on signal from the switching pieces 30a and 30b.

As can be seen from FIG. 1, a knob 94 of the writing protection switch SW and a recess 95 in which the knob 94 slides are formed on a side of the memory card MC. When the memory card MC is properly inserted, the front end portion of the switching piece 31b runs upon the knob 94 or falls in the recess 95 alternatively corresponding to the position of the knob 94 in the recess 95. When the front end portion of the switching piece 31b falls in the recess 95, the front end portion of the switching piece 31b contacts the front end portion of the other switching piece 31a. By applying a predetermined voltage between the switching pieces 31a and 31b, a switching on signal can be outputted from the switching pieces 31a and 31b. It is possible to sense whether the memory card MC is in the writing protection mode or not by the external sensing circuit with using the switching on or off signal from the switching pieces 31a and 31b.

The movement of the slider 5 can be restricted by fitting the hook 16b of the rod 16 into the recess 15d of the heart cam 15a. The memory card MC, however, can forcibly be extracted from the housing 3 of the connector 100, or the memory card MC is dropped from the housing 3 of the connector due to vibrations or impact, if there is no locking mechanism. In the embodiment, the locking member 50 which is to be engaged with the cutting 93 of the memory card MC is provided with the slider 5. When the slider 5 on which the memory card MC is properly held is moved to the predetermined position and the hook 16b of the rod 16 is stopped at the locking position in the recess 15d of the heart cam 15a, the front end of the protrusion 50b of the locking member 50 extruded into the recess 15d of the hart cam groove 15 is pressed backward by the hook 16b of the rod 16. The rear end portion of the lever portion 50a is elastically deformed for warping toward the memory card MC by the pressing force. Then, the locking hook 50d extrudes from the concave portion 39 and engages with the cutting 93 of the memory card MC. Thus, the memory card MC is locked so as not to be drawn out from the housing 3 of the connector 100.

For drawing the memory card MC from the connector 100, the end of the memory card MC protruded from the opening 42 of the housing 3 is further pushed so as to move the memory card MC with the slider 5 to the rear end of the housing 3. By such the movement, the locking of the hook 16b of the rod 16 and the hart cam groove 15 is released, and the hook 16b of the rod 16 relatively moves forward in the fifth sub-groove 155. Since the dead end wall of the fifth sub-groove 155 facing the recess 15d of the heart cam 15a is sloped and the elevation of the bottom of the fifth sub-groove 155 is lower than that of the fourth sub-groove 154, the hook 16b must proceed to the sixth sub-groove 156, and stops at a position P4. The elevation of the bottom of the sixth sub-groove 156 is the lowest in the heart cam groove 15.

When the pressing forces to the memory card MC is released, the slider 5 moves forward due to the pressing forces of the coil springs 13. The hook 16b relatively moves backward in the sixth sub-groove 156 corresponding to the forward movement of the slider 5. Since the elevation of the bottom of the fifth sub-groove 155 is higher than that of the sixth sub-groove 156, the hook 16b must proceed to the seventh sub-groove 157.

When the hook 16b of the rod 16 is disengaged from the recess 15d, the protrusion 50b of the locking member 50 receives no pressing force for pressing backward, so that the front end of the protrusion 50b extrudes into the recess 15d and the locking hook 50d of the locking member 50 is evacuated into the concave portion 39 due to the elastic restitution force of the lever portion 50a of the locking member 50. Thus, the locking of the cutting 93 of the memory card MC by the locking hook 50d of the locking member 50 is released.

Subsequently, the hook 16b of the rod 16 proceeds in the seventh sub-groove 157 and reaches to the eighth sub-groove 158. The bottom of the seventh sub-groove 157 are sloped so that the elevation of the bottom of the eights sub-groove 158 is higher than that of the first sub-groove 151. When the hook 16b further proceeds from the eighth sub-groove 158, it falls into the first sub-groove 151 and returns to the initial position P1. At this time, the slider 5 returns to the initial state. The memory card MC is largely protruded from the opening 42 of the housing 3 of the connector 100, and the memory card MC can be taken out from the connector 100.

Even though an abnormal force is applied to the memory card MC when the memory card MC is pulled out, since the locking hook 50d is not engaged with the cutting 93 of the memory card MC, it is possible to prevent the deformation of the locking member 50 including the licking hook 50d and so on.

The use of the connector in accordance with the present invention is not limited to the above-mentioned memory card recording and reproducing apparatus, so that it is needless to say that the connector can be used in another use. Furthermore, the counter part member of the contact for the connector in accordance with the present invention is not limited to the electric power terminals of the memory card or the like, so that it is possible to use the contact to other terminals for recording and reproducing the data and so on.

This application is based on Japanese patent application 2002-316602 filed in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

1. A connector comprising a housing having an opening, through which a counterpart member to be mounted on the connector is inserted, and a plurality of contacts, which is arranged in an inside of the housing and to be contacted with terminals provided on the counterpart member, wherein
at least one contact among the contacts has three plate spring portions respectively arranged in parallel, and three contact portions respectively formed in the vicinity of front ends of the plate spring portions; and
two plate spring portions among the three plate spring portions are integrally coupled at the front end portions thereof.

2. The connector in accordance with claim 1, wherein
the plate spring portions positioned at both sides of the three plate spring portions are integrally coupled at front end portion of them; and
a length of the plate spring portion positioned at the center is shorter than the lengths of the plate spring portions positioned at the both sides.

3. The connector in accordance with claim 2, wherein
a contact portion formed on the plate spring portion positioned at the center is backwardly positioned than contact portions formed on the plate springs positioned at the both sides.

4. The connector in accordance with claim 3, wherein
the contact portions are respectively warped in a manner to protrude a direction to contact with terminals of the counterpart member.

5. The connector in accordance with claim 1, wherein
the contact contacts with an electric power terminal of the counterpart member, and is used for supplying electric power.

6. The connector in accordance with claim 1, wherein
the counterpart member is a memory card.

7. A contact for a connector formed by processing a metal plate into a predetermined shape comprising:
three plate spring portions respectively arranged in parallel in the vicinity of a front end thereof, and three contact portions respectively formed in the vicinity of front ends of the plate spring portions; and
two plate spring portions among the three plate spring portions being integrally coupled at the front end portions thereof.

8. The contact in accordance with claim 7, wherein
the plate spring portions positioned at both sides of the three plate spring portions are integrally coupled at front end portion of them; and
a length of the plate spring portion positioned at the center is shorter than the lengths of the plate spring portions positioned at the both sides.

9. The contact in accordance with claim 8, wherein
a contact portion formed on the plate spring portion positioned at the center is backwardly positioned than contact portions formed on the plate springs positioned at the both sides.

10. The contact in accordance with claim 9, wherein
the contact portions are respectively warped in a manner to protrude a direction to contact with terminals of the counterpart member.
